(19) United States
(12) Patent Application Publication
(10) Pub. No.: US 2026/0302362 A1
(43) Pub. Date: Oct. 1, 2026

(54) ALL-SOLID-STATE BATTERY

(71) Applicant: HONDA MOTOR CO., LTD., Tokyo (JP)

(72) Inventors: Daisuke Kaneko, Wako-shi (JP); Takuro Sasano, Wako-shi (JP); Shuji Futagami, Wako-shi (JP); Yoshito Akune, Wako-shi (JP)

(21) Appl. No.: 19/549,167

(22) Filed: Feb. 25, 2026

(30) Foreign Application Priority Data
Mar. 31, 2025 (JP) 2025-059807

(51) Int. Cl. H01M 10/0585; H01M 10/0562; H01M 10/42; H01M 50/586

(52) U.S. Cl. CPC H01M 10/0585; H01M 10/0562; H01M 10/4235; H01M 50/586

(57) ABSTRACT

Disclosed is an all-solid-state battery including a stacked body in which a positive electrode current collector, a positive electrode active material layer, an insulating layer, a solid-state electrolyte layer, a negative electrode active material layer, and a negative electrode current collector are stacked, wherein a protrusion length (a) of the negative electrode active material layer from an end portion of the positive electrode active material layer to an end portion of the negative electrode active material layer, a protrusion length (b) of the solid-state electrolyte layer from the end portion of the positive electrode active material layer to an end portion of the solid-state electrolyte layer, a protrusion length (c) of the insulating layer from the end portion of the positive electrode active material layer to an outer side end portion of the insulating layer, a thickness (tₛ) of the solid-state electrolyte layer, a thickness (tₚ) of the insulating layer, and a voltage (d) during discharging satisfy relationships of a<b<c and c−b+tₛ+tₚ>0.2/12×d.

### CROSS-REFERENCE TO RELATED APPLICATION

Priority is claimed on Japanese Patent Application No. 2025-059807, filed Mar. 31, 2025, the content of which is incorporated herein by reference.

### BACKGROUND OF THE INVENTION

### Field of the Invention

The present invention relates to an all-solid-state battery.

### Description of Related Art

In recent years, research and development into secondary batteries that contribute to energy efficiency has been performed to ensure that more people have access to affordable, reliable, sustainable, and advanced energy. Among secondary batteries, all-solid-state batteries have been attracting attention due to their excellent properties in terms of safety, life time, output, and the like.

In all-solid-state batteries, dendrites (branched crystals) of metallic lithium may be precipitated in a negative electrode layer during charging. In addition, if the adhesion at an interface between a negative electrode layer and a solid-state electrolyte layer is reduced due to repeated charging and discharging, this may promote the precipitation of dendrites of lithium metal and the like. When lithium ions are precipitated at an end portion of the solid-state electrolyte layer, and the like, the precipitated lithium accumulates, which may cause a short circuit between a positive electrode layer and a negative electrode layer, may cause a local side reaction, thereby increasing a resistance inside the battery, and may cause a deterioration in cycle characteristics.

In an all-solid-state battery including a stacked structure constituted by a positive electrode layer, a solid-state electrolyte layer, a negative electrode layer, and the like, in order to reduce the precipitation of lithium metal during charging, there is known a method in which a solid-state electrolyte layer having a high ion conductivity is disposed on an inner side in a direction perpendicular to a stacking direction and a solid-state electrolyte layer having a low ion-conductivity is disposed on an outer side in the direction perpendicular to the stacking direction, and a position of an outer peripheral end of the positive electrode layer and an arrangement of the solid-state electrolyte layer having a high ion conductivity and the solid-state electrolyte layer having a low ion conductivity are controlled (see, for example, Patent Document 1). That is, according to the all-solid-state battery disclosed in Patent Document 1, the position of the outer peripheral end of the positive electrode layer, a position of an inner peripheral end of an insulating layer, and the overlap of the solid-state electrolyte layer having a low ion conductivity are designed to be appropriately disposed in a plan view. By doing so, concentrated stresses are generated at the outer peripheral end of the positive electrode layer and the inner peripheral end of the insulating layer due to pressure applied in a thickness direction of each layer, and low ion conductive portions are disposed at these concentrated stress locations, thereby making it possible to reduce the precipitation of lithium metal during charging.

However, even if it is possible to reduce the precipitation of lithium metal during charging to a certain extent by controlling the arrangement of the end portions of the stacked body to have a specific configuration as in the all-solid-state battery disclosed in Patent Document 1, there is still room for improvement in order to provide an all-solid-state battery that prevents a short circuit between the positive electrode layer and the negative electrode layer when charging and discharging are repeated and has excellent cycle characteristics.

### Patent Documents

[Patent Document 1] Japanese Unexamined Patent Application, First Publication No. 2023-47083

### SUMMARY OF THE INVENTION

The present invention has been made in view of the above circumstances, and an object of the present invention is to provide an all-solid-state battery that prevents a short circuit between a positive electrode layer and a negative electrode layer even when charging and discharging are repeated and has excellent cycle characteristics. This in turn contributes to energy efficiency.

The present inventors have studied a relationship between a voltage of an all-solid-state battery, a thickness of each layer of a stacked body included in the battery, and an arrangement of an outer peripheral end of each layer, and have found that when these satisfy a specific relationship, a short circuit between a positive electrode layer and a negative electrode layer can be more effectively prevented even when charging and discharging are repeated. In addition, the present inventors have found that by controlling the size of the solid-state electrolyte layer to be within a specific range, it is possible to efficiently suppress the generation of a burr during manufacturing, thereby suppressing the precipitation of lithium ions, particularly, the growth of dendrites, at the end portion of the solid-state electrolyte layer and the like even when charging and discharging are repeated, and it is possible to suppress a short circuit between the positive electrode layer and the negative electrode layer and a local side reaction, and have completed the present invention.

That is, the present invention includes the following aspects.
[1] An all-solid-state battery including a stacked body that includes a positive electrode current collector, a positive electrode active material layer, an insulating layer, a solid-state electrolyte layer, a negative electrode active material layer, and a negative electrode current collector,
   wherein the positive electrode current collector, the positive electrode active material layer, the solid-state electrolyte layer, the negative electrode active material layer, and the negative electrode current collector are stacked in that order and the insulating layer is disposed so as to surround an outer periphery of the positive electrode active material layer,
   wherein each layer of the stacked body is configured such that, in a plan view, an outer peripheral end of the positive electrode active material layer, an outer peripheral end of the negative electrode active material layer, an outer peripheral end of the solid-state electrolyte layer, and an outer peripheral end of the insulating layer are located further outward in that order, and
   wherein, in a cross section parallel to a stacking direction passing through a straight line parallel to a longitudinal direction of the stacked body,
   when a difference between a shortest distance from a center of the negative electrode active material layer in the longitudinal direction to one end portion of the negative electrode active material layer in the longitudinal direction and a shortest distance from a center of the positive electrode active material layer in the longitudinal direction to an end portion of the positive electrode active material layer in the longitudinal direction on the same side as the end portion of the negative electrode active material layer is defined as a,
   a difference between a shortest distance from a center of the solid-state electrolyte layer in the longitudinal direction to an end portion of the solid-state electrolyte layer in the longitudinal direction on the same side as the end portion of the negative electrode active material layer and a shortest distance from a center of the positive electrode active material layer in the longitudinal direction to an end portion of the positive electrode active material layer in the longitudinal direction on the same side as the end portion of the negative electrode active material layer is defined as b,
   a difference between a shortest distance from a center of the positive electrode active material layer in the longitudinal direction to an outer side end portion of the insulating layer on the same side as the end portion of the negative electrode active material layer and a shortest distance from a center of the positive electrode active material layer in the longitudinal direction to an end portion of the positive electrode active material layer in the longitudinal direction on the same side as the end portion of the negative electrode active material layer is defined as c,
   a thickness of the solid-state electrolyte layer at the end portion of the solid-state electrolyte layer is defined as tₛ,
   a thickness of the insulating layer at the outer side end portion of the insulating layer is defined as tₚ, and
   a voltage during discharging is defined as d (V),
   a relationship of a<b<c is satisfied and a relationship of c−b+tₛ+tₚ>0.2/12×d is satisfied.

According to the all-solid-state battery of [1], the protrusion length (a) of the negative electrode active material layer from the end portion of the positive electrode active material layer to the end portion of the negative electrode active material layer, the protrusion length (b) of the solid-state electrolyte layer from the end portion of the positive electrode active material layer to the end portion of the solid-state electrolyte layer, the protrusion length (c) of the insulating layer from the end portion of the positive electrode active material layer to the outer side end portion of the insulating layer, the thickness (tₛ) of the solid-state electrolyte layer, and the thickness (tₚ) of the insulating layer satisfy the above-described relationships. Therefore, even when charging and discharging are repeated, metal is less likely to accumulate at the end portion of the solid-state electrolyte layer. In addition, even if metal is precipitated at the end portion of the solid-state electrolyte layer, the creepage distance from the negative electrode active material layer to the positive electrode current collector is large, and thus a short circuit between the positive electrode layer and the negative electrode layer can be suppressed, and cycle characteristics are improved.
[2] The all-solid-state battery according to [1], which includes the stacked body further including an intermediate layer between the negative electrode active material layer and the solid-state electrolyte layer, wherein, in a plan view of the stacked body, an outer peripheral end of the intermediate layer is located outside an outer peripheral end of the negative electrode active material layer and is located at the same position as or inside an outer peripheral end of the solid-state electrolyte layer.

According to the all-solid-state battery of [2], the precipitation of metal, particularly, the growth of dendrites, can be suppressed, and the metal is less likely to accumulate at the end portion of the solid-state electrolyte layer even when charging and discharging. Therefore, it is possible to further suppress a short circuit between the positive electrode layer and the negative electrode layer, thereby improving cycle characteristics.
[3] The all-solid-state battery according to [1] or [2], wherein the b, c, and tₛ satisfy a relationship of c−b >tₛ.

According to the all-solid-state battery [3], the generation of a burr of the solid-state electrolyte layer can be efficiently suppressed during the manufacture of the all-solid-state battery. Therefore, even when charging and discharging are repeated, the precipitation of the metal, particularly, the growth of dendrites, at the end portion of the solid-state electrolyte layer or the like can be suppressed, and a short circuit between the positive electrode layer and the negative electrode layer and a local side reaction can be further suppressed.
[4] The all-solid-state battery according to any one of [1] to [3], wherein when a distance from one end portion to the other end portion of the negative electrode active material layer in the longitudinal direction is defined as e, the a, b, and e satisfy a relationship of b>a+(e×0.01).

According to the all-solid-state battery of [4], even if the all-solid-state battery is pressed at high pressure in the stacking direction, the elongation rate of the negative electrode active material layer in a direction perpendicular to the stacking direction is taken into consideration, and thus the configurations [1] to [3] above can be provided more accurately and/or stably.
[5] The all-solid-state battery according to any one of [1] to [4],
   wherein, in a cross section parallel to a stacking direction passing through a straight line parallel to a lateral direction of the stacked body,
   when a difference between a shortest distance from a center of the negative electrode active material layer in the lateral direction to one end portion of the negative electrode active material layer in the lateral direction and a shortest distance from a center of the positive electrode active material layer in the lateral direction to an end portion of the positive electrode active material layer in the lateral direction on the same side as the end portion of the negative electrode active material layer is defined as a′,
   a difference between a shortest distance from a center of the solid-state electrolyte layer in the lateral direction to an end portion of the solid-state electrolyte layer in the lateral direction on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as b′,
   a difference between a shortest distance from a center of the positive electrode active material layer in the lateral direction to an outer side end portion of the insulating layer on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as c′,
   a thickness of the solid-state electrolyte layer at the end portion of the solid-state electrolyte layer is defined as tₛ′,
   a thickness of the insulating layer at the outer side end portion of the insulating layer is defined as tₚ′, and
   a voltage during discharging is defined as d (V),
   a relationship of a′<b′<c′ is satisfied and a relationship of c′−b′+tₛ′+tₚ′>0.2/12×d is satisfied.

According to the all-solid-state battery of [5], in a direction different from that of the above [1] to [4], the protrusion length (a′) of the negative electrode active material layer from the end portion of the positive electrode active material layer to the end portion of the negative electrode active material layer, the protrusion length (b′) of the solid-state electrolyte layer from the end portion of the positive electrode active material layer to the end portion of the solid-state electrolyte layer, the protrusion length (c′) of the insulating layer from the end portion of the positive electrode active material layer to the outer side end portion of the insulating layer, the thickness (tₛ′) of the solid-state electrolyte layer, and the thickness (tₚ′) of the insulating layer satisfy the above-described relationships. As a result, even when charging and discharging are repeated, metal is further less likely to accumulate at the end portion of the solid-state electrolyte layer. In addition, even if metal is precipitated at the end portion of the solid-state electrolyte layer, the creepage distance from the negative electrode active material layer to the positive electrode current collector is large, and thus a short circuit between the positive electrode layer and the negative electrode layer can be suppressed, and cycle characteristics are further improved.
[6] The all-solid-state battery according to [5], wherein the b′, c′, and tₛ′ satisfy a relationship of c′−b′>tₛ′.

According to the all-solid-state battery of [6], in a direction different from that of the above [1] to [4], the protrusion length (b′) of the solid-state electrolyte layer from the end portion of the positive electrode active material layer to the end portion of the solid-state electrolyte layer, the protrusion length (c′) of the insulating layer from the end portion of the positive electrode active material layer to the outer side end portion of the insulating layer, and the thickness (tₛ′) of the solid-state electrolyte layer satisfy the above-described relationship. As a result, the generation of a burr of the solid-state electrolyte layer can be further efficiently suppressed during the manufacture of the all-solid-state battery. Therefore, even when charging and discharging are repeated, the precipitation of the metal, particularly, the growth of dendrites, at the end portion of the solid-state electrolyte layer or the like can be further suppressed, and a short circuit between the positive electrode layer and the negative electrode layer and a local side reaction can be further suppressed.
[7] The all-solid-state battery according to [5] or [6], wherein, when a distance from one end portion to the other end portion of the negative electrode active material layer in the lateral direction is defined as e′, the a′, b′, and e′ satisfy a relationship of b′>a′+(e′×0.01).

According to the all-solid-state battery of [7], in a direction different from that of the above [1] to [4], the protrusion length (a′) of the negative electrode active material layer from the end portion of the positive electrode active material layer to the end portion of the negative electrode active material layer, the protrusion length (b′) of the solid-state electrolyte layer from the end portion of the positive electrode active material layer to the end portion of the solid-state electrolyte layer, and the distance (e′) from one end portion to the other end portion of the negative electrode active material layer satisfy the above-described relationship. As a result, even if the all-solid-state battery is pressed at high pressure in the stacking direction, in a direction different from that of the above [1] to [4], the elongation rate of the negative electrode active material layer in a direction perpendicular to the stacking direction is taken into consideration, and thus the configurations [5] and [6] above can be provided more easily and/or stably.
[8] The all-solid-state battery according to any one of [5] to [7], wherein the a, b, c, tₛ, and tₚ are the same in magnitude as the a′, b′, c′, tₛ′, and tₚ′, respectively.

According to the all-solid-state battery of [8], it is possible to suppress a difference in the characteristics of the all-solid-state battery in a different direction in a plan view.

According to the present invention, it is possible to efficiently and/or stably provide an all-solid-state battery that prevents a short circuit between a positive electrode layer and a negative electrode layer even when charging and discharging are repeated and has excellent cycle characteristics.

### BRIEF DESCRIPTION OF THE DRAWINGS

FIG. 1 is a plan view of a stacked body of an all-solid-state battery according to one embodiment of the present invention.

FIG. 2 is a cross-sectional view along line A-A′ in FIG. 1.

FIG. 3 is a cross-sectional view along line B-B′ in FIG. 1.

FIG. 4 is a graph showing a relationship between a protrusion length (c-b) of an insulating layer from an end portion of a solid-state electrolyte layer to an end portion of the insulating layer and a height of a burr in the solid-state electrolyte layer which is generated during manufacturing in an all-solid-state battery according to one embodiment of the present invention.

### DETAILED DESCRIPTION OF THE INVENTION

An all-solid-state battery according to an embodiment of the present invention will be described with reference to the drawings. However, the following embodiments are merely examples of the present invention, and the present invention is not limited to the following. In addition, in the drawings used in the following description, the scale of each member may be appropriately changed such that each member is of a recognizable size.

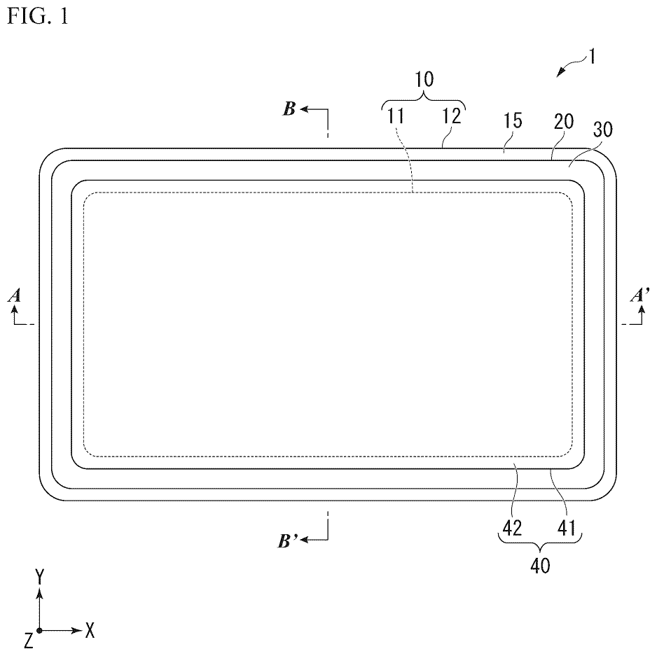

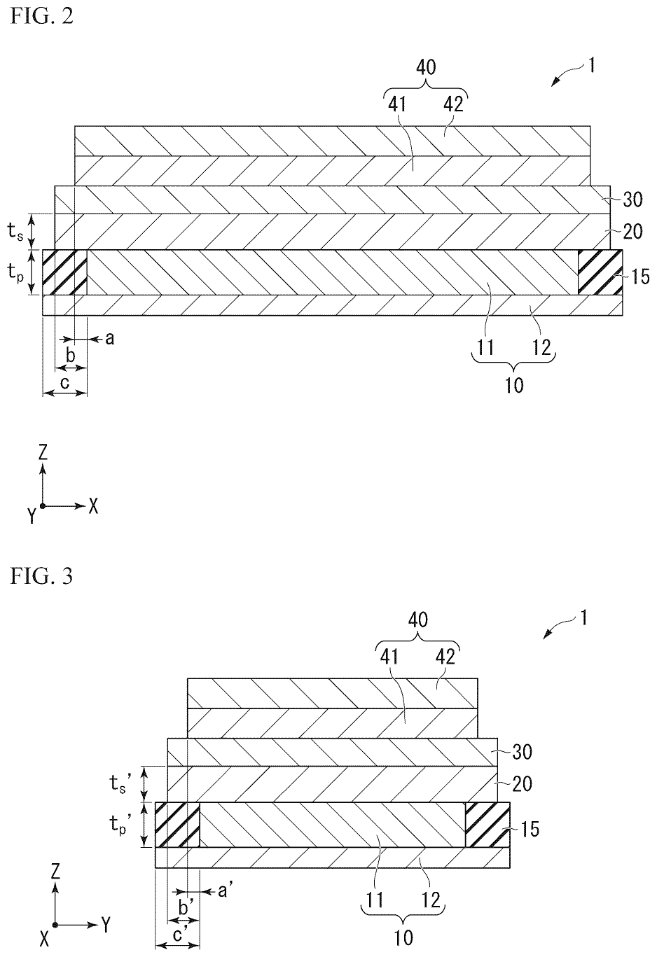

FIG. 1 is a plan view of a stacked body (also referred to as an electrode stacked body) of an all-solid-state battery according to one embodiment of the present invention. FIG. 2 is a cross-sectional view along line A-A′ in FIG. 1, and FIG. 3 is a cross-sectional view along line B-B′ in FIG. 1.

In FIGS. 1 to 3, when the stacked body is viewed from above, a longitudinal direction is indicated as an X direction, a lateral direction is indicated as a Y direction, and a stacking direction is indicated as a Z direction.

The stacked body 1 of the all-solid-state battery according to one embodiment of the present invention may be, as shown in FIG. 1, a rectangle in which a length in the X direction is longer than a length in the Y direction in a plan view, but is not limited thereto. The stacked body 1 may be a square in which the length in the X direction and the length in the Y direction are the same, or may be a circle, an ellipse, or an oval in a plan view.

As shown in FIG. 2, the stacked body 1 includes at least a positive electrode current collector 12, a positive electrode active material layer 11, an insulating layer 15, a solid-state electrolyte layer 20, a negative electrode active material layer 41, and a negative electrode current collector 42, in which the positive electrode current collector 12, the positive electrode active material layer 11, the solid-state electrolyte layer 20, the negative electrode active material layer 41, and the negative electrode current collector 42 are stacked in this order, and the insulating layer 15 is disposed so as to surround an outer periphery of the positive electrode active material layer 11. It is preferable that a thickness of the positive electrode active material layer 11 and a thickness of the insulating layer 15 be the same. If the thickness of the positive electrode active material layer 11 and the thickness of the insulating layer 15 differ from each other, unevenness will occur on a surface formed by these layers, which may cause distortion or warping of a structure of the stacked body 1. By making the thickness of the positive electrode active material layer 11 and the thickness of the insulating layer 15 the same, a higher quality all-solid-state battery can be manufactured.

The positive electrode current collector 12 and the positive electrode active material layer 11 may be collectively referred to as a positive electrode layer 10, and the negative electrode active material layer 41 and the negative electrode current collector 42 may be collectively referred to as a negative electrode layer 40.

As shown in FIG. 2, the stacked body 1 may include an intermediate layer 30 between the negative electrode active material layer 41 and the solid-state electrolyte layer 20. In the stacked body 1, the positive electrode current collector 12, the positive electrode active material layer 11, the insulating layer 15, the solid-state electrolyte layer 20, and the negative electrode active material layer 41 are configured such that, in a plan view, an outer peripheral end of the positive electrode active material layer 11, an outer peripheral end of the negative electrode active material layer 41, an outer peripheral end of the solid-state electrolyte layer 20, and an outer peripheral end of the insulating layer 15 are located further outward in that order, as shown in FIG. 1. In a case in which the stacked body 1 includes the intermediate layer 30, an outer peripheral end of the intermediate layer 30 may be configured to be at the same position as the outer peripheral end of the solid-state electrolyte layer 20 in a plan view, as shown in FIG. 1, or may be configured to be located inside the outer peripheral end of the solid-state electrolyte layer 20 and outside the outer peripheral end of the negative electrode active material layer 41, although this is not shown.

In a plan view, a maximum distance from one end portion to the other end portion of the outer peripheral end of the insulating layer 15 in the X direction may be 450 to 550 mm, 480 to 540 mm, or 500 to 530 mm. In a plan view, a maximum distance from one end portion to the other end portion of the outer peripheral end of the insulating layer 15 in the Y direction may be 70 to 120 mm, 80 to 110 mm, or 85 to 105 mm.

By providing the intermediate layer 30, it is possible to stabilize the precipitation of metal, and in particular to reduce the growth of dendrites in the negative electrode active material layer 41 during charging. In addition, by arranging the outer peripheral end of the intermediate layer 30 as described above, it is possible to reduce the precipitation of the metal, particularly, the growth of dendrites, at the end portion of the intermediate layer 30 and also to suppress a local side reaction due to contact between the negative electrode active material layer 41 or the metal precipitated on the negative electrode active material layer 41 and the solid-state electrolyte layer 20. Furthermore, in a case in which the negative electrode layer 40 is stacked on the intermediate layer 30 during manufacturing, it is possible to reduce the generation of a burr on the negative electrode layer 40 in the vicinity of the end portion of the intermediate layer 30.

### Positive Electrode Current Collector

The positive electrode current collector 12 constitutes the positive electrode layer 10 together with the positive electrode active material layer 11. In one embodiment of the present invention, the positive electrode active material layer 11 is stacked on the positive electrode current collector 12, and the insulating layer 15 is disposed on the positive electrode current collector 12 so as to surround an outer periphery of the positive electrode active material layer 11. An area of the positive electrode current collector 12 in a plan view is preferably equal to an area of the positive electrode active material layer 11 in a plan view or greater than the area of the positive electrode active material layer 11 in a plan view. That is, the positive electrode current collector 12 is preferably large enough to cover a surface of the positive electrode active material layer 11 on a side of the positive electrode current collector 12, and may also cover a surface of the insulating layer 15 on a side of the positive electrode current collector 12. An example of a shape of the positive electrode current collector 12 includes a plate shape, a foil shape, or the like.

The positive electrode current collector 12 is not particularly limited as long as it functions as a current collector in the positive electrode layer 10, and any positive electrode current collector known per se as a positive electrode current collector of an all-solid-state battery, can be used.

Examples of a material that forms the positive electrode current collector 12 include aluminum, an aluminum alloy, stainless steel, nickel, iron, titanium, and the like. Of these, aluminum, an aluminum alloy, and stainless steel are preferred, and aluminum is particularly preferred.

### Positive Electrode Active Material Layer

As a material that forms the positive electrode active material layer 11, a material known per se as a material that forms a positive electrode active material layer of an all-solid-state battery, can be used. As a positive electrode active material, for example, a lithium-containing layered active material, a spinel-type active material, and an olivine-type active material can be used. More specifically, an example of the positive electrode active material includes a compound represented by LiCoO₂, LiNiO₂, LiNiₚMn_{q}CoᵣO₂ (p+q+r=1), LiNiₚAl_{q}CoᵣO₂ (p+q+r=1), LiMn₂O₄, Li₁₊ₓMn_{2-x-y}MO₄ (x+y=2, M=at least one element selected from Al, Mg, Co, Fe, Ni, and Zn), or LiM_{P}O₄ (M=at least one element selected from Fe, Mn, Co, and Ni), lithium titanate, or the like.

The positive electrode active material layer 11 may contain a solid-state electrolyte from the viewpoint of a charge transfer medium conductivity, may contain a conductive assistant from the viewpoint of an electrical conductivity, or a binder from the viewpoint of a flexibility. As the solid-state electrolyte, the conductive assistant, and the binder, those known to be used in the field of a positive electrode active material layer of an all-solid-state battery, can be used.

### Insulating Layer

The insulating layer 15 is not particularly limited as long as it can electrically insulate the positive electrode current collector 12 and/or the positive electrode active material layer 11 and prevent a short circuit between the positive electrode layer and the negative electrode layer. For example, it is preferable that the insulating layer 15 have a volume resistivity of 1×10¹² Ω·cm or more at 20° C. and a dielectric insulation breakdown voltage per unit thickness of 10 kV/mm or more, more preferably 100 kV/mm or more.

The insulating layer 15 may be formed of either an organic material or an inorganic material. For example, as the insulating layer 15, one or more materials selected from, for example, rubber; glass; a resin such as polyimide, polybenzimidazole, polyamideimide, polyetherimide, polyacetal, polyphenylene sulfide, polyether ether ketone, tetrafluoroethylene, polyamide 6 (also known as nylon 6), ultra-high molecular weight polyethylene, polyethylene, polypropylene, a vinyl chloride resin, polystyrene, polyethylene terephthalate, or an ABS resin; a ceramics such as alumina, zirconia, silicon nitride, aluminum nitride, mullite, steatite, magnesia, sialon, or macerite, and the like, can be used.

The insulating layer 15 may further include a binder and other additives.

### Solid-State Electrolyte Layer

The solid-state electrolyte layer 20 is present between the positive electrode layer 10 and the negative electrode layer 40 and has a function of conducting a charge transfer medium between the positive electrode layer 10 and the negative electrode layer 40.

In the stacked body 1, the solid-state electrolyte layer 20 is stacked on a layer constituted by the positive electrode active material layer 11 and the insulating layer 15.

The material that forms the solid-state electrolyte layer 20 is not particularly limited as long as it has a conductivity of the charge transfer medium, and an example thereof includes sulfide-based solid-state electrolyte materials, oxide-based solid-state electrolyte materials, nitride-based solid-state electrolyte materials, halide-based solid-state electrolyte materials, or the like.

As the sulfide-based solid-state electrolyte materials, for example, the sulfide-based solid-state electrolyte materials formed from a raw material composition containing Li₂S and P₂S₅, can be used, and the sulfide-based solid-state electrolyte materials may have an argyrodite-type crystal structure.

An example of the oxide-based solid-state electrolyte materials includes a NASICON-type oxide, a garnet-type oxide, a perovskite-type oxide, or the like.

An example of the NASICON-type oxide includes an oxide containing Li, Al, Ti, P, and O, such as Li_{1.5}Al_{0.5}Ti_{1.5}(PO₄)₃. An example of the garnet-type oxide includes an oxide containing Li, La, Zr, and O, such as Li₇La₃Zr₂O₁₂. An example of the perovskite oxide includes an oxide containing Li, La, Ti and O, such as LiLaTiO₃.

The solid-state electrolyte layer 20 may further contain a binder, and as such a binder, a binder known to be used in the field of a solid-state electrolyte layer of an all-solid-state battery, can be used. Examples of a material of the binder include polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), hydrogenated nitrile rubber (HNBR), and the like. These may be used alone or in combination of two or more.

In one embodiment, the material of the solid-state electrolyte layer 20 is preferably in a particulate form, and preferably has a median diameter (D50) of 0.5 to 10 μm, for example.

### Intermediate Layer

In a case in which the stacked body 1 has the intermediate layer, the intermediate layer 30 is stacked between the solid-state electrolyte layer 20 and the negative electrode layer 40.

Since the intermediate layer 30 is present, it is possible to suppress the precipitation of the metal ions, particularly the growth of dendrites, at an interface with the negative electrode layer 40 and it is also possible to improve the interface adhesion.

The intermediate layer 30 preferably has an electron conductivity and has porosities that allow the metal ions, such as lithium ions, which are charge transfer media, to pass through. Since the intermediate layer 30 has the porosities, when the all-solid-state battery is charged, the metal ions that move from the solid-state electrolyte layer 20 toward the negative electrode layer 40 pass through the intermediate layer 30 and are precipitated on a surface of the negative electrode layer 40 on a side of the intermediate layer 30. By passing the metal ions through the intermediate layer 30, it is possible to uniformly form a metal precipitation layer on the surface of the negative electrode layer 40. In addition, since the intermediate layer 30 has the porosities, the intermediate layer 30 can absorb a change in the thickness of the negative electrode layer 40, which occurs with charging and discharging, within a certain range. For this reason, even when the all-solid-state battery is repeatedly charged and discharged, the interface adhesion can be maintained.

A porosity of the intermediate layer 30 is preferably higher than a porosity of the solid-state electrolyte layer 20. As a result, many porosities that allow the metal ions to pass through are formed inside the intermediate layer 30, and thus it is possible to more uniformly precipitate the metal on the surface of the negative electrode layer 40. In addition, since the intermediate layer 30 becomes more flexible, the ability to absorb a change in the thickness of the negative electrode layer 40 is improved. The porosity of the intermediate layer 30 can be, for example, 40% to 70%.

In one embodiment, the thickness of the intermediate layer 30 may be 5 μm or less, may be 3 μm or less, or may be in the range of 1 to 3 μm. Since the intermediate layer 30 has such a thickness, the frequency of direct contact between the solid-state electrolyte layer 20 and the precipitated metal can be significantly reduced, local deterioration of the solid-state electrolyte layer 20 and current concentration can be suppressed, and cycle characteristics and storage characteristics can be improved.

A material that forms the intermediate layer 30 preferably contains amorphous carbon and metal nanoparticles. The intermediate layer 30 may further contain a binder as a binding material to maintain its structure.

The amorphous carbon is difficult to alloy with metal such as lithium, and therefore can suppress the formation of dendrites, thereby improving the cycle characteristics of the all-solid-state battery. The amorphous carbon may be either easily graphitizable carbon (also called soft carbon) or hardly graphitizable carbon (also called hard carbon). In addition, the amorphous carbon may be any carbon allotrope as long as it does not exhibit a clear crystalline state, and may be an aggregate of fine graphite crystals. An example of the amorphous carbon includes carbon blacks such as acetylene black, furnace black, and ketjen black, coke, an activated carbon, a carbon nanotube (CNT), fullerene, graphene, or the like.

An example of the metal nanoparticles includes metal nanoparticles of tin (Sn), silicon (Si), zinc (Zn), magnesium (Mg), gold (Au), platinum (Pt), palladium (Pd), silver (Ag), aluminum (Al), bismuth (Bi), antimony (Sb), or the like. The content of the metal nanoparticles is preferably more than 0 mass % and 30 mass % or less relative to the mass of the intermediate layer 30. Since the intermediate layer 30 contains the metal nanoparticles, it is possible to increase the electron conductivity of the intermediate layer 30, and it is possible to precipitate the metal more uniformly. In addition, since the metal nanoparticles have a higher Young's modulus than the amorphous carbon, the structure of the intermediate layer 30 can be maintained even in a case in which the intermediate layer 30 is pressed under high pressure during the manufacturing of the all-solid-state battery.

The particle size of the particles such as the amorphous carbon and the metal nanoparticles is preferably smaller than the particle size of the solid-state electrolyte material. As a result, it is possible to cause the intermediate layer 30 to penetrate into a gap between the solid-state electrolyte materials that form the interface of the solid-state electrolyte layer 20, and thus it is possible to increase the contact area between the solid-state electrolyte layer 20 and the intermediate layer 30, and it is possible to improve the adhesion. The particle size of the amorphous carbon may be, for example, in the range of 0.02 to 0.10 μm in terms of median diameter (D50), and the particle size of the metal nanoparticles may be, for example, in the range of 0.02 to 0.20 μm in terms of median diameter (D50).

The binder of the intermediate layer 30 is preferably a binder that can improve the adhesion between the particles that constitute the intermediate layer 30 and between the intermediate layer 30 and the solid-state electrolyte layer 20. The binder is not particularly limited, and any binder generally used in the all-solid-state battery, can be used. An example of a material of the binder of the intermediate layer 30 includes an acrylic acid polymer, a cellulose polymer, a styrene polymer, a vinyl acetate polymer, a urethane polymer, a fluoroethylene polymer, a PVDF polymer, or the like.

### Negative Electrode Current Collector

The negative electrode current collector 42 constitutes the negative electrode layer 40 together with the negative electrode active material layer 41. In one embodiment of the present invention, the negative electrode active material layer 41 is stacked on the solid-state electrolyte layer 20, and the negative electrode current collector 42 is stacked on the negative electrode active material layer 41. In addition, in another embodiment of the present invention, the anode active material layer 41 is stacked on the intermediate layer 30 that is stacked on the solid-state electrolyte layer 20, and the negative electrode current collector 42 is stacked on the negative electrode active material layer 41. An example of a shape of the negative electrode current collector 42 includes a plate shape, a foil shape, or the like.

The negative electrode current collector 42 is not particularly limited as long as it functions as a current collector in the negative electrode layer 40, and any negative electrode current collector known per se as a positive electrode current collector of an all-solid-state battery, can be used.

An example of a material that forms the negative electrode current collector 42 includes nickel, copper, stainless steel, or the like. Of these, copper is preferred.

### Negative Electrode Active Material Layer

The negative electrode active material layer 41 has the function of absorbing and releasing lithium ions. As a material that forms the negative electrode active material layer 41, a material known per se as a material that forms a negative electrode active material layer of an all-solid-state battery, can be used. An example of the negative electrode active material includes metallic lithium, a lithium alloy, a metal oxide, a metal sulfide, a metal nitride, Si, SiO, a carbon material, or the like. An example of the carbon materials includes artificial graphite, natural graphite, hard carbon, soft carbon, or the like.

In a case in which the metallic lithium or the lithium alloy is used as the negative electrode active material, the metallic lithium may be precipitated on the surface of the negative electrode current collector 42 by charging the all-solid-state battery, or a lithium alloy layer can be formed on the surface of the negative electrode current collector 42 by charging the all-solid-state battery in a state in which metal that forms an alloy with lithium may be stacked on the surface of the negative electrode current collector 42. An example of the metal that forms an alloy with lithium includes magnesium, silicon, gold, silver, indium, germanium, tin, lead, aluminum, zinc, or the like.

The negative electrode active material layer 41 may further contain a conductive assistant, a binder, or the like, as necessary. As the conductive assistant or the binder, that known to be used in the field of a negative electrode active material layer of an all-solid-state battery, can be used.

In one embodiment, at least a part of either end portion of the negative electrode current collector 42 in the X direction may extend in the X direction to form a negative electrode tab (not shown), and at least a part of either end of the positive electrode current collector 12 in the X direction may extend in the X direction to form a positive electrode tab (not shown). The negative electrode tab and the positive electrode tab preferably extend in opposite directions in the X direction. With this configuration, when a plurality of stacked bodies 1 are stacked, the positive electrodes and negative electrodes can be easily connected in parallel.

FIG. 2 shows a cross-sectional view along line A-A′ in FIG. 1, and line A-A′ in FIG. 1 may be a straight line that passes through the center of a main surface of the stacked body 1 in a plan view, for example, a main surface of the negative electrode current collector 42, and is parallel to the X direction. FIG. 3 shows a cross-sectional view along line B-B′ in FIG. 1, and line B-B′ in FIG. 1 may be a straight line that passes through the center of a main surface of the stacked body 1 in a plan view, for example, a main surface of the negative electrode current collector 42, and is parallel to the Y direction.

In this specification, for example, in a plan view of an arbitrary layer included in the stacked body 1, the center of the main surface of the stacked body 1 in a plan view can be defined as a position of an intersection point between a straight line that is present on the main surface of the layer, passes through a midpoint of a line segment that is present on a straight line parallel to the X direction and has both ends at the two end portions of the layer, and is parallel to the Y direction, and a straight line that is present on the main surface of layer, passes through a midpoint of a line segment that is present on a straight line parallel to the Y direction and has both ends at the two end portions of the layer, and is parallel to the X direction.

The dimensional design of each layer constituting the stacked body 1 will be described below with reference to FIGS. 2 and 3. In the present invention, it is preferable that the relationship between the layers shown in FIG. 2 or 3 be satisfied in a cross section in the stacking direction, taken along an arbitrary straight line passing through the center of the main surface of the stacked body 1 in a plan view. By arranging the layers constituting the stacked body 1 in this manner, a short circuit between the positive electrode layer and the negative electrode layer can be suppressed at any end portion of each layer even when charging and discharging are repeated.

In the stacked body 1, each layer is configured such that, when a difference between a shortest distance from a center of the negative electrode active material layer 41 in the longitudinal direction (the X direction) to one end portion (a left end portion in FIG. 2) of the negative electrode active material layer 41 in the longitudinal direction and a shortest distance from a center of the positive electrode active material layer 11 in the longitudinal direction (the X direction) to an end portion (a left end portion in FIG. 2) of the positive electrode active material layer 11 in the longitudinal direction on the same side as the end portion of the negative electrode active material layer 41 is defined as a, a difference between a shortest distance from a center of the solid-state electrolyte layer 20 in the longitudinal direction (the X direction) to an end portion (a left end portion in FIG. 2) of the solid-state electrolyte layer 20 in the longitudinal direction on the same side as the end portion of the negative electrode active material layer 41 and a shortest distance from a center of the positive electrode active material layer 11 in the longitudinal direction to an end portion (a left end portion in FIG. 2) of the positive electrode active material layer 11 in the longitudinal direction on the same side as the end portion of the negative electrode active material layer 41 is defined as b, a difference between a shortest distance from a center of the positive electrode active material layer 11 in the longitudinal direction (the X direction) to an outer side end portion (a left end portion in FIG. 2) of the insulating layer 15 on the same side as the end portion of the negative electrode active material layer 41 and a shortest distance from a center of the positive electrode active material layer 11 in the longitudinal direction (the X direction) to an end portion (a left end portion in FIG. 2) of the positive electrode active material layer 11 in the longitudinal direction on the same side as the end portion of the negative electrode active material layer 41 is defined as c, a thickness of the solid-state electrolyte layer 20 at the end portion of the solid-state electrolyte layer 20 is defined as tₛ, a thickness of the insulating layer 15 at the outer side end portion of the insulating layer 15 is defined as tₚ, and a voltage during discharging is defined as d (V), a relationship of a<b<c is satisfied and a relationship of c−b+tₛ+tₚ>0.2/12×d is satisfied.

As shown in FIG. 2, the difference a between a shortest distance from a center of the negative electrode active material layer 41 in the longitudinal direction (the X direction) to one end portion (a left end portion in FIG. 2) of the negative electrode active material layer 41 in the longitudinal direction and a shortest distance from a center of the positive electrode active material layer 11 in the longitudinal direction (the X direction) to an end portion (a left end portion in FIG. 2) of the positive electrode active material layer 11 in the longitudinal direction on the same side as the end portion of the negative electrode active material layer 41 corresponds to a protrusion length (a) of the negative electrode active material layer 41 from the end portion of the positive electrode active material layer 11 to the end portion of the negative electrode active material layer 41, the difference b between a shortest distance from a center of the solid-state electrolyte layer 20 in the longitudinal direction (the X direction) to an end portion (a left end portion in FIG. 2) of the solid-state electrolyte layer 20 in the longitudinal direction on the same side as the end portion of the negative electrode active material layer 41 and a shortest distance from a center of the positive electrode active material layer 11 in the longitudinal direction to an end portion (a left end portion in FIG. 2) of the positive electrode active material layer 11 in the longitudinal direction on the same side as the end portion of the negative electrode active material layer 41 corresponds to a protrusion length (b) of the solid-state electrolyte layer 20 from the end portion of the positive electrode active material layer 11 to the end portion of the solid-state electrolyte layer 20, and the difference c between a shortest distance from a center of the positive electrode active material layer 11 in the longitudinal direction (the X direction) to an outer side end portion (a left end portion in FIG. 2) of the insulating layer 15 on the same side as the end portion of the negative electrode active material layer 41 and a shortest distance from a center of the positive electrode active material layer 11 in the longitudinal direction (the X direction) to an end portion (a left end portion in FIG. 2) of the positive electrode active material layer 11 in the longitudinal direction on the same side as the end portion of the negative electrode active material layer 41 corresponds to a protrusion length (c) of the insulating layer 15 from the end portion of the positive electrode active material layer 11 to the outer side end portion of the insulating layer 15.

By configuring each layer such that the relationship of a<b<c is satisfied, even when charging and discharging are repeated, it is possible to curb the metal precipitated on the negative electrode layer 40 from moving around and accumulating at the end portion of the solid-state electrolyte layer 20, and it is also possible to suppress a local side reaction caused by the contact between the precipitated metal and the solid-state electrolyte layer 20. On the other hand, if each layer is configured such that the a, b, and c are to be the relationship of b<a<c, the precipitation of the metal, particularly the growth of dendrites, occurs in the negative electrode layer 40, and these precipitates come into contact with the solid-state electrolyte layer 20, causing a local side reaction that increases the resistance within the battery, or destroying the local structure of the solid-state electrolyte layer 20, thereby allowing the precipitated metal to penetrate into the destroyed structural portion and further promote the growth of dendrites, and increasing the risk of a short circuit between the positive electrode layer and the negative electrode layer and possibly deteriorating the cycle characteristics. On the other hand, if each layer is configured such that the a, b, and c are to be the relationship of a<c≤b, a burr is likely to be generated at the end portion of the solid-state electrolyte layer 20 during the manufacturing of the stacked body 1, and while charging and discharging are repeated, the risk of promoting the precipitation of the metal ions, particularly, the growth of dendrites, at the end portion of the solid-state electrolyte layer 20, and the like increases. In addition, a creepage distance from the negative electrode active material layer 41 to the positive electrode current collector 12, which will be described below, becomes smaller, thereby increasing the risk of a short circuit between the positive electrode layer and the negative electrode layer.

In the stacked body 1, c−b+tₛ+tₚ corresponds to the creepage distance from the negative electrode active material layer 41 to the positive electrode current collector 12. The larger the creepage distance, the greater the distance from the negative electrode layer 40 to the positive electrode current collector 12, and thus even if metal is precipitated on the negative electrode layer 40, it is possible to reduce a possibility that the precipitated metal will reach the positive electrode current collector 12 and cause a short circuit. On the other hand, the amount of the metal precipitated on the negative electrode layer 40 tends to increase as the voltage during the discharging of the all-solid-state battery increases. Therefore, in order to prevent a short circuit, it is necessary to take into consideration the voltage during the discharging of the all-solid-state battery when determining the creepage distance. The present inventors have focused on the relationship between the voltage d (V) during the discharging of such an all-solid-state battery and the creepage distance, and have found that when each layer is configured such that the creepage distance (c−b+tₛ+tₚ) satisfies the relationship c−b+tₛ+tₚ>0.2/12×d, a short circuit between the positive electrode layer and the negative electrode layer can be suppressed. That is, according to JIS C 0704-1995, the creepage distance (insulation creepage distance) required for insulation at a voltage of 12 (V) is 0.2 mm, and there can be a linear relationship between the voltage and the insulation creepage distance, and thus it has been found that by calculating a product of the voltage d (V) during the discharging of the all-solid-state battery according to the present invention and the creepage distance per unit voltage (0.2/12) (mm/V) derived from JIS C 0704-1995, and making the creepage distance (c−b+tₛ+tₚ) (mm) according to the present invention greater than the product, a short circuit between the positive electrode layer and the negative electrode layer can be suppressed. Here, as the voltage, a so-called open circuit voltage can be employed. In one embodiment, the open circuit voltage employed in the present invention is an open circuit voltage immediately after the all-solid-state battery according to the present invention is fully charged in an initial stage of manufacture. In another embodiment, the open circuit voltage employed in the present invention is an open circuit voltage immediately after the all-solid-state battery according to the present invention is fully charged during any use process.

The open circuit voltage of the all-solid-state battery targeted in the present invention can be adjusted by appropriately changing the material, size, or manufacturing conditions of each layer constituting the stacked body 1. In addition, it can be checked by one or several times of trial manufacture.

In the stacked body 1, the larger the creepage distance (c−b+tₛ+tₚ), the greater the effect of suppressing a short circuit between the positive electrode layer and the negative electrode layer. Therefore, from the viewpoint of the short circuit suppression effect, the upper limit of the creepage distance is not particularly limited. However, in the all-solid-state battery, a compact size is generally required for the same electrical capacity. Therefore, as the upper limit value of the creepage distance, a value obtained by adding 0.1 to 5 mm, 0.1 to 3 mm, or 0.1 to 2 mm to a value of 0.2/12×d (mm), as necessary, can be set.

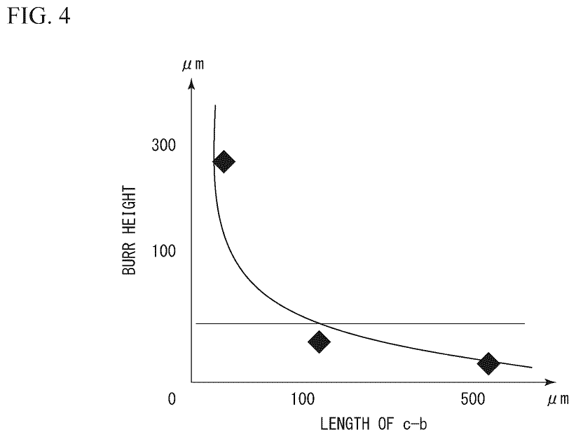

In one embodiment, in stacked body 1, each layer is configured such that the b, c, and tₛ satisfy the relationship c−b>tₛ. The length c−b corresponds to the protrusion length of the insulating layer 15 from the end portion of the solid-state electrolyte layer 20 to the outer side end portion of the insulating layer 15. As shown in FIG. 4, as the length of c−b becomes shorter, the burr that is generated on the solid-state electrolyte layer 20 tends to become significantly larger. Therefore, by adjusting the length of c−b to a constant length, it is possible to efficiently suppress the burr that is generated on the solid-state electrolyte layer 20 during manufacturing. The present inventors have focused that the greater the thickness tₛ of the end portion of the solid-state electrolyte layer 20, the greater the elongation deformation of the solid-state electrolyte layer 20 and the greater the height of the burr that is generated, and have found that by configuring each layer so as to satisfy the relationship c−b>tₛ, it is possible to efficiently suppress the generation of the burr at the end portion of the solid-state electrolyte layer 20 or the like, during the manufacturing of the all-solid-state battery. As a result, in such an all-solid-state battery, even when charging and discharging are repeated, the precipitation of the metal, particularly, the growth of dendrites, at the end portion of the solid-state electrolyte layer 20 or the like can be suppressed, and a short circuit between the positive electrode layer 10 and the negative electrode layer 40 and a local side reaction in the solid-state electrolyte layer 20 or the like can be further suppressed.

In the stacked body 1, the longer the protrusion length (c−b) of the insulating layer 15 from the end of the solid-state electrolyte layer 20 to the outer end of the insulating layer 15, the greater the effect of suppressing the generation of the burr at the end portion of the solid-state electrolyte layer 20 or the like, and therefore, from the viewpoint of the effect of suppressing the generation of the burr, the upper limit of the protrusion length (c−b) of the insulating layer 15 is not particularly limited. However, in the all-solid-state battery, a compact size is generally required for the same electrical capacity. Therefore, as the upper limit value of the protrusion length (c−b) of the insulating layer 15, a value obtained by adding 0.1 to 5 mm, 0.1 to 3 mm, or 0.1 to 2 mm to a value of the thickness tₛ of the end portion of the solid-state electrolyte layer 20, as necessary, can be set.

As will be described later, the stacked body 1 is manufactured by pressing at high pressure in the stacking direction. Therefore, taking into consideration the elongation rate of 1 (%) in the longitudinal direction (the X direction) of the negative electrode active material layer 41 when pressed at high pressure during manufacturing, when the length of the negative electrode active material layer 41 in the longitudinal direction (the X direction) is e, by configuring the layer such that the a, b, and e satisfy the relationship b >a+(e×0.01), the all-solid-state battery according to the present invention can be provided more accurately and/or stably.

In the stacked body 1, the larger the protrusion length (b) of the solid-state electrolyte layer 20 from the end portion of the positive electrode active material layer 11 to the end portion of the solid-state electrolyte layer 20, the more easily the relationship of b >a+(e×0.01) can be satisfied. Therefore, from the viewpoint of ease of manufacturing the target all-solid-state battery, the upper limit of the protrusion length (b) of the solid-state electrolyte layer 20 is not particularly limited. However, in the all-solid-state battery, a compact size is generally required for the same electrical capacity. Therefore, as the upper limit value of the protrusion length (b) of the solid-state electrolyte layer 20, a value obtained by adding 0.1 to 5 mm, 0.1 to 3 mm, or 0.1 to 2 mm to a value of a+(e×0.01), as necessary, can be set.

The above is an explanation of the dimensional design for a left end portion in FIG. 2. However, it goes without saying that it is preferable that a right end portion be configured in the same way from the viewpoint of suppressing a short circuit between the positive electrode layer and the negative electrode layer and improving cycle characteristics. In a case in which the values corresponding to a, b, c, tₛ, and tₚ at the left end portion are different from those at the right end portion, the average value can be taken to determine whether or not the dimensional design falls within the scope of the present invention.

FIG. 3 shows a cross section of the stacked body 1 in a direction perpendicular to the cross section of FIG. 2 in a plan view. In FIG. 3, a′, b′, c′, tₛ′, and tₚ′ are values corresponding to a, b, c, tₛ, and tₚ in FIG. 2, respectively. From the viewpoint of suppressing a short circuit between the positive electrode layer and the negative electrode layer and improving cycle characteristics, it is preferable that the structure including a′, b′, c′, tₛ′, and tₚ′ be configured to satisfy the same relationship as the structure including a, b, c, tₛ, and tₚ. In addition, in FIG. 3, in a case in which the values corresponding to a′, b′, c′, tₛ′, and tₚ′ at the left end portion are different from those at the right end portion, the average value can be taken to determine whether or not the dimensional design falls within the scope of the present invention.

In addition, the values corresponding to a, b, c, tₛ, and tₚ in FIG. 2 may be equal to the values corresponding to a′, b′, c′, tₛ′, and tₚ′ in FIG. 3, respectively. By making these values equal, it is possible to suppress a difference in the characteristics of the all-solid-state battery in a different direction in a plan view.

In one embodiment, the stacked body 1 is an all-solid-state battery housed in an exterior body (not shown). In such an embodiment, a positive electrode tab extending to the positive electrode current collector 12 of the stacked body 1 and a negative electrode tab extending to the negative electrode current collector 42 are configured to protrude from the exterior body, or the positive electrode current collector 12 and the negative electrode current collector 42 of the stacked body 1 are connected to a positive electrode tab and a negative electrode tab configured to protrude from the exterior body, respectively, inside the exterior body.

The thickness of the stacked body 1 can be changed with charging and discharging, and thus the exterior body is preferably configured to accommodate the change in the thickness of the stacked body 1. As the material of the exterior body, a laminate film can be used. An example of the laminate film includes a stacked film having a three-layered structure in which an inner side resin layer, a metal layer, and an outer side resin layer are stacked in that order from the inside. The outer side resin layer may be, for example, a polyamide (also called nylon) layer or a polyethylene terephthalate (PET) layer, the metal layer may be, for example, an aluminum layer, and the inner side resin layer may be, for example, a polyethylene layer or a polypropylene layer. The laminate film preferably has layers that are integrated together by adhesive, heat, pressure, or the like.

In one embodiment, the all-solid-state battery housed in the exterior body may be further sandwiched by a restraining member such that a restraining force is applied in the stacking direction of the stacked body 1. Since the all-solid-state battery has such a configuration, it is possible to suppress a change in the thickness of the stacked body 1, which occurs with charging and discharging, and it is also possible to cause the metal to be uniformly precipitated on the surface of the negative electrode layer 40 during charging, and thus it is possible to suppress the precipitation of the metal, particularly the growth of dendrites. As such a restraining member, a restraining member known per se in the field of an all-solid-state battery, can be used. The restraining force exerted by the restraining member is preferably, for example, 0.1 to 10 MPa.

In the stacked body 1 shown in FIG. 2, the positive electrode active material layer 11, the solid-state electrolyte layer 20, the intermediate layer 30, the negative electrode active material layer 41, and the negative electrode current collector 42 are stacked in that order in the Z direction with respect to the positive electrode current collector 12. However, in another embodiment, it is possible to form a stacked body 2 in which the positive electrode active material layer 11, the solid-state electrolyte layer 20, the intermediate layer 30, the negative electrode active material layer 41, and the negative electrode current collector 42 are further stacked in that order in a −Z direction with respect to the positive electrode current collector 12 of the stacked body 1. That is, the stacked body 2 can be a stacked body in which the positive electrode active material layer 11, the solid-state electrolyte layer 20, the intermediate layer 30, the negative electrode active material layer 41, and the negative electrode current collector 42 are stacked in approximate plane symmetry with respect to the positive electrode current collector 12.

In still another embodiment, the battery may be an all-solid-state battery in which a plurality of stacked bodies 2 are stacked and housed in the exterior body. The number of the plurality of stacked bodies 2 may be 2-40, 10-40, or 20-30.

A plurality of positive electrode current collectors 12 and negative electrode current collectors 42 present in the plurality of stacked bodies 2 housed in the exterior body are connected in parallel inside the exterior body and are further connected to the positive electrode tabs and negative electrode tabs configured to protrude from the exterior body, respectively. In addition, the all-solid-state battery that includes the plurality of stacked bodies 2 housed in the exterior body may be further sandwiched by a restraining member such that a restraining force is applied in the stacking direction of the plurality of stacked bodies 2 that are stacked.

A configuration in which the plurality of stacked bodies 2 are stacked and housed in the exterior body is sometimes referred to as a cell of an all-solid-state battery. Such a cell can be used singly or in multiples connected in parallel or series, as necessary.

### Method for Manufacturing Stacked Body

The stacked body 1 can be manufactured by using a method known per se in the field of an all-solid-state battery and adjusting each layer to conform to the above-Mentioned dimensional design.

For example, the stacked body 1 can be manufactured by a method including a positive electrode layer preparation step, a solid-state electrolyte layer formation step, an intermediate layer formation step, and a negative electrode layer formation step.

In the case of an embodiment in which the stacked body 1 does not include the intermediate layer, the intermediate layer forming step can be omitted.

The positive electrode layer preparation step is a step of preparing the positive electrode layer 10.

The positive electrode layer 10 can be manufactured, for example, by forming the positive electrode active material layer 11 on the surface of a positive electrode current collector 12. As a method for forming the positive electrode active material layer 11, a method in which a slurry containing constituent components of the positive electrode active material layer is applied and then dried, can be used. As the slurry containing the constituent components of the positive electrode active material layer, a dispersion of a positive electrode active material, which contains a solvent, a positive electrode active material, and optionally a conductive assistant, and a binder, can be used. In the positive electrode layer preparation step, it is preferable to arrange the insulating layer 15 so as to surround the outer periphery of the positive electrode active material layer 11.

The solid-state electrolyte layer forming step is a step of forming the solid-state electrolyte layer 20 on the surface of the positive electrode active material layer 11 of the positive electrode layer 10. As a method for forming the solid-state electrolyte layer 20, a method in which a slurry containing the constituent components of the solid-state electrolyte layer is directly applied to the surface of the positive electrode active material layer 11 and then dried, or a method in which a slurry containing the constituent components of the solid-state electrolyte layer is applied to the surface of a separately prepared support sheet and then dried to form the solid-state electrolyte layer 20, and then the solid-state electrolyte layer 20 is transferred to the surface of the positive electrode active material layer 11 under a specific pressure, can be used.

As the slurry containing the constituent components of the solid-state electrolyte layer, a dispersion of a solid-state electrolyte, which contains a solvent, a solid-state electrolyte, and optionally a binder, can be used. In addition, as a method for forming the solid-state electrolyte layer 20, a method in which the solid-state electrolyte layer is integrated with a substrate, made independent, and then disposed on the positive electrode layer, can be used. As the substrate, for example, a nonwoven fabric or a woven fabric can be used. As the base material, a polyester resin such as PET can be adopted.

The intermediate layer forming step is a step of forming the intermediate layer 30 on the surface of the solid-state electrolyte layer 20 on a side opposite to the side of the positive electrode active material layer 11. As a method for forming the intermediate layer 30, a method in which a slurry containing the constituent components of the intermediate layer is directly applied to the surface of the solid-state electrolyte layer 20 and then dried, or a method in which a slurry containing the constituent components of the intermediate layer is applied to the surface of a separately prepared support sheet and then dried to form the intermediate layer 30, and then the intermediate layer 30 is transferred to the surface of the solid-state electrolyte layer 20 under a specific pressure, can be used.

As the slurry containing the constituent components of the intermediate layer, a dispersion of an intermediate forming material, which contains a solvent, metal nanoparticles, amorphous carbon, and optionally a binder, can be used.

The negative electrode layer forming step is a step of forming the negative electrode layer 40 on the surface of the intermediate layer 30 on a side opposite to the side of the solid-state electrolyte layer 20. The negative electrode layer 40 can be manufactured, for example, by forming the negative electrode active material layer 41 on the surface of the intermediate layer 30 and then stacking the negative electrode current collector 42 on the surface of the negative electrode active material layer 41. As a method for forming the negative electrode active material layer 41 on the surface of the intermediate layer 30, a method in which a slurry containing the constituent components of the negative electrode active material layer is applied to the surface of the intermediate layer 30 and then dried, or a method in which a slurry containing the constituent components of the negative electrode active material layer is applied to the surface of a separately prepared support sheet and then dried to form the negative electrode active material layer 41, and then the negative electrode active material layer 41 is transferred to the surface of the intermediate layer 30 under a specific pressure, can be used.

As the slurry containing the constituent components of the negative electrode active material layer, a dispersion of a negative electrode active material, which contains a solvent, a negative electrode active material, and optionally a conductive assistant, and a binder, can be used.

The negative electrode layer 40 can be manufactured by stacking the negative electrode current collector 42 on the surface of the negative electrode active material layer 41 formed as described above.

In a case in which the stacked body 1 does not include the intermediate layer 30, the negative electrode active material layer 41 may be formed on the surface of the solid-state electrolyte layer 20 instead of on the surface of the intermediate layer 30.

The intermediate layer forming step and the negative electrode layer forming step may be carried out simultaneously. For example, the intermediate layer 30 of a stacked body of the intermediate layer and the negative electrode layer, in which the intermediate layer 30 and the negative electrode layer 40 are integrated in advance with each other and made independent, may be stacked on the surface of the solid-state electrolyte layer 20. The stacked body of the intermediate layer and the negative electrode layer can be manufactured, for example, by forming the negative electrode active material layer 41 in advance on the surface of the negative electrode current collector 42, applying a slurry containing the constituent components of the intermediate layer to the surface of the negative electrode active material layer 41, and drying the slurry to form the intermediate layer 30.

As a method for forming the negative electrode active material layer 41 on the surface of the negative electrode current collector 42, a method in which a slurry containing the constituent components of the negative electrode active material layer is applied to the surface of the negative electrode current collector 42 and then dried, or a method in which a slurry containing the constituent components of the negative electrode active material layer is applied to the surface of a separately prepared support sheet and then dried to form the negative electrode active material layer 41, and then the negative electrode active material layer 41 is transferred to the surface of the negative electrode current collector 42 under a specific pressure, can be used.

In addition, in a case in which metallic lithium or a lithium alloy is used as the negative electrode active material layer 41, the negative electrode current collector 42 is stacked on the surface of the solid-state electrolyte layer 20 or the intermediate layer 30 such that a metal layer that forms an alloy with lithium is provided at the negative electrode current collector 42 or an interface between the negative electrode current collector 42 and the solid-state electrolyte layer 20 or the intermediate layer 30, and when the all-solid-state battery is charged, metallic lithium can be precipitated on the surface of the negative electrode current collector 42, or a lithium alloy layer can be formed.

Each step can be adjusted to achieve the dimensional design of each layer in the stacked body 1 described above.

In this manner, it is possible to manufacture the stacked body 1 in which the positive electrode layer 10, the solid-state electrolyte layer 20, the intermediate layer 30, and the negative electrode layer 40 are stacked in that order. The obtained stacked body 1 can be optionally pressed in the stacking direction to increase the density of the stacked body 1. In addition, the method of pressing the stacked body 1 after the stacked body 1 is formed is not limited, and pressing can be performed in any of the steps described above. As a result, it is possible to flatten the surface to be stacked before other layers are stacked thereon, and thus it is possible to improve product precision.

The stacked body in which each layer is stacked in the Z direction and the −Z direction of the positive electrode current collector 12, like the stacked body 2, can be manufactured by forming each layer simultaneously or successively on both sides of the positive electrode current collector 12. Each layer is preferably formed by a method in which a layer formed on the surface of a separately prepared support sheet is transferred to the surface to be stacked under a specific pressure.

In a case in which the stacked body 1 or 2 is housed in the exterior body to be manufactured as a product, it can be manufactured, for example, as follows. One end portion of the positive electrode tab is connected to the positive electrode current collector 12 of the obtained stacked body 1 or 2, and one end portion of the negative electrode tab is connected to the negative electrode current collector 42 of the obtained stacked body 1 or 2. Next, the stacked body 1 or 2 is housed in the exterior body such that the other end portions of the positive electrode tab and the negative electrode tab protrude from the exterior body, and the exterior body is sealed. Optionally, a restraining member is disposed on the outer side surface of the exterior body to restrain the stacked body 1 or 2 with a specific restraining force.

In addition, in a case in which the plurality of stacked bodies 2 are stacked and housed in the exterior body to be manufactured as a product, the plurality of stacked bodies 2 can be stacked and housed in the exterior body by a method known per se in the field of an all-solid-state battery. The plurality of positive electrode current collectors 12 of the plurality of stacked bodies 2 are connected to one end portion of the positive electrode tab, and the plurality of negative electrode current collector 42 are connected to one end portion of the negative electrode tab. Next, the plurality of stacked bodies 2 that are stacked are housed in the exterior body such that the other end portions of the positive electrode tab and the negative electrode tab protrude from the exterior body, and the exterior body is sealed. Then, optionally, a restraining member is disposed on the outer side surface of the exterior body, and the plurality of stacked bodies 2 that are stacked are restrained with a specific restraining force.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Stacked body of all-solid-state battery
10 Positive electrode layer
11 Positive electrode active material layer
12 Positive electrode current collector
15 Insulating layer (insulating frame)
20 Solid-state electrolyte layer
30 Intermediate layer
40 Negative electrode layer
41 Negative electrode active material layer
42 Negative electrode current collector

What is claimed is:

1. An all-solid-state battery comprising a stacked body that includes a positive electrode current collector, a positive electrode active material layer, an insulating layer, a solid-state electrolyte layer, a negative electrode active material layer, and a negative electrode current collector,
wherein the positive electrode current collector, the positive electrode active material layer, the solid-state electrolyte layer, the negative electrode active material layer, and the negative electrode current collector are stacked in that order and the insulating layer is disposed so as to surround an outer periphery of the positive electrode active material layer,
wherein each layer of the stacked body is configured such that, in a plan view, an outer peripheral end of the positive electrode active material layer, an outer peripheral end of the negative electrode active material layer, an outer peripheral end of the solid-state electrolyte layer, and an outer peripheral end of the insulating layer are located further outward in that order, and
wherein, in a cross section parallel to a stacking direction passing through a straight line parallel to a longitudinal direction of the stacked body,
when a difference between a shortest distance from a center of the negative electrode active material layer in the longitudinal direction to one end portion of the negative electrode active material layer in the longitudinal direction and a shortest distance from a center of the positive electrode active material layer in the longitudinal direction to an end portion of the positive electrode active material layer in the longitudinal direction on the same side as the end portion of the negative electrode active material layer is defined as a,
a difference between a shortest distance from a center of the solid-state electrolyte layer in the longitudinal direction to an end portion of the solid-state electrolyte layer in the longitudinal direction on the same side as the end portion of the negative electrode active material layer and a shortest distance from a center of the positive electrode active material layer in the longitudinal direction to an end portion of the positive electrode active material layer in the longitudinal direction on the same side as the end portion of the negative electrode active material layer is defined as b,
a difference between a shortest distance from a center of the positive electrode active material layer in the longitudinal direction to an outer side end portion of the insulating layer on the same side as the end portion of the negative electrode active material layer and a shortest distance from a center of the positive electrode active material layer in the longitudinal direction to an end portion of the positive electrode active material layer in the longitudinal direction on the same side as the end portion of the negative electrode active material layer is defined as c,
a thickness of the solid-state electrolyte layer at the end portion of the solid-state electrolyte layer is defined as tₛ,
a thickness of the insulating layer at the outer side end portion of the insulating layer is defined as tₚ, and
a voltage during discharging is defined as d (V),
a relationship of a<b<c is satisfied and a relationship of c−b+tₛ+tₚ>0.2/12×d is satisfied.

2. The all-solid-state battery according to claim 1, which comprises the stacked body further comprising an intermediate layer between the negative electrode active material layer and the solid-state electrolyte layer, wherein, in a plan view of the stacked body, an outer peripheral end of the intermediate layer is located outside an outer peripheral end of the negative electrode active material layer and is located at the same position as or inside an outer peripheral end of the solid-state electrolyte layer.

3. The all-solid-state battery according to claim 1, wherein the b, c, and tₛ satisfy a relationship of c−b>tₛ.

4. The all-solid-state battery according to claim 2, wherein the b, c, and tₛ satisfy a relationship of c−b>tₛ.

5. The all-solid-state battery according to claim 1, wherein, when a distance from one end portion to the other end portion of the negative electrode active material layer in the longitudinal direction is defined as e, the a, b, and e satisfy a relationship of b>a+(e×0.01).

6. The all-solid-state battery according to claim 2, wherein, when a distance from one end portion to the other end portion of the negative electrode active material layer in the longitudinal direction is defined as e, the a, b, and e satisfy a relationship of b>a+(e×0.01).

7. The all-solid-state battery according to claim 1,
wherein, in a cross section parallel to a stacking direction passing through a straight line parallel to a lateral direction of the stacked body,
when a difference between a shortest distance from a center of the negative electrode active material layer in the lateral direction to one end portion of the negative electrode active material layer in the lateral direction and a shortest distance from a center of the positive electrode active material layer in the lateral direction to an end portion of the positive electrode active material layer in the lateral direction on the same side as the end portion of the negative electrode active material layer is defined as a′,
a difference between a shortest distance from a center of the solid-state electrolyte layer in the lateral direction to an end portion of the solid-state electrolyte layer in the lateral direction on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as b′,
a difference between a shortest distance from a center of the positive electrode active material layer in the lateral direction to an outer side end portion of the insulating layer on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as c′,
a thickness of the solid-state electrolyte layer at the end portion of the solid-state electrolyte layer is defined as tₛ′,
a thickness of the insulating layer at the outer side end portion of the insulating layer is defined as tₚ′, and
a voltage during discharging is defined as d (V),
a relationship of a′<b′<c′ is satisfied and a relationship of c′−b′+tₛ′+tₚ′>0.2/12×d is satisfied.

8. The all-solid-state battery according to claim 2,
wherein, in a cross section parallel to a stacking direction passing through a straight line parallel to a lateral direction of the stacked body,
when a difference between a shortest distance from a center of the negative electrode active material layer in the lateral direction to one end portion of the negative electrode active material layer in the lateral direction and a shortest distance from a center of the positive electrode active material layer in the lateral direction to an end portion of the positive electrode active material layer in the lateral direction on the same side as the end portion of the negative electrode active material layer is defined as a′,
a difference between a shortest distance from a center of the solid-state electrolyte layer in the lateral direction to an end portion of the solid-state electrolyte layer in the lateral direction on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as b′,
a difference between a shortest distance from a center of the positive electrode active material layer in the lateral direction to an outer side end portion of the insulating layer on the same side as the end portion of the negative electrode active material layer and a shortest distance from a center of the positive electrode active material layer in the lateral direction to an end portion of the positive electrode active material layer in the lateral direction on the same side as the end portion of the negative electrode active material layer is defined as c′,
a thickness of the solid-state electrolyte layer at the end portion of the solid-state electrolyte layer is defined as tₛ′,
a thickness of the insulating layer at the outer side end portion of the insulating layer is defined as tₚ′, and
a voltage during discharging is defined as d (V),
a relationship of a′<b′<c′ is satisfied and a relationship of c′−b′+tₛ′+tₚ′>0.2/12×d is satisfied.

9. The all-solid-state battery according to claim 7, wherein the b′, c′, and tₛ′ satisfy a relationship of c′−b′>tₛ′.

10. The all-solid-state battery according to claim 8, wherein the b′, c′, and tₛ′ satisfy a relationship of c′−b′>tₛ′.

11. The all-solid-state battery according to claim 7, wherein, when a distance from one end portion to the other end portion of the negative electrode active material layer in the lateral direction is defined as e′, the a′, b′, and e′ satisfy a relationship of b′>a′+(e′×0.01).

12. The all-solid-state battery according to claim 8, wherein, when a distance from one end portion to the other end portion of the negative electrode active material layer in the lateral direction is defined as e′, the a′, b′, and e′ satisfy a relationship of b′>a′+(e′×0.01).

13. The all-solid-state battery according to claim 7, wherein the a, b, c, tₛ, and tₚ are the same in magnitude as the a′, b′, c′, tₛ′, and tₚ′, respectively.

14. The all-solid-state battery according to claim 8, wherein the a, b, c, tₛ, and tₚ are the same in magnitude as the a′, b′, c′, tₛ′, and tₚ′, respectively.
